(19) United States
(12) Patent Application Publication
(10) Pub. No.: US 2025/0127681 A1
(43) Pub. Date: Apr. 24, 2025

(54) SOFT ACTUATOR AND MASSAGE DEVICE FOR VEHICLE SEAT

(71) Applicants: Hyundai Motor Company, Seoul (KR); Kia Corporation, Seoul (KR); Korea Advanced Institute of Science and Technology, Daejeon (KR)

(72) Inventors: Kyoung Jin Chang, Suwon (KR); Jeong Goo Kang, Seongnam (KR); Dong Chul Park, Anyang (KR); Hyun Woo Kim, Daejeon (KR); Ki Uk Kyung, Daejeon (KR); Kyu Jin Hyeon, Daejeon (KR); David Santiago Diaz Cortes, Daejeon (KR)

(21) Appl. No.: 18/596,282

(22) Filed: Mar. 5, 2024

(30) Foreign Application Priority Data
Oct. 18, 2023 (KR) 10-2023-0139648

(51) Int. Cl. A61H 23/02; B60N 2/90

(52) U.S. Cl. CPC A61H 23/02; B60N 2/976; A61H 2201/169; A61H 2203/0431

(57) ABSTRACT

A soft actuator for a massage device is capable of providing vibration and pressure. The soft actuator includes a soft pressing portion that expands or contracts by a pressure fluid filling in the soft pressing portion, and a soft vibrating portion including an electrode that provides vibration through shape change due to voltage applied to the electrode. The soft actuator may be included as part of a massage device, which may be incorporated into a vehicle seat.

### CROSS-REFERENCE TO RELATED APPLICATION

This application claims under 35 U.S.C. § 119(a) the benefit of Korean Patent Application No. 10-2023-0139648, filed on Oct. 18, 2023, the entire contents of which are incorporated herein by reference.

### BACKGROUND

### (a) Technical Field

The present disclosure relates to a soft actuator capable of providing vibration and pressure, more particularly, to the soft actuator that is incorporated into a massage device as part of a vehicle seat.

### (b) Description of the Related Art

A soft actuator is an actuator made of an elastic material and having a flexible structure. The soft actuator is actively used in research in the field of soft robots in contrast to rigid robots. The soft actuator includes a deformable body and may be actuated using fluid, heat, electricity, magnetism, chemical reactions, etc.

The soft actuator may be applied to various fields, such as a wearable device and a massage device. The massage device may be utilized in the automobile industry, for example, for a vehicle seat.

The above information disclosed in this Background section is only for enhancement of understanding of the background of the present disclosure, and therefore it may contain information that does not form the prior art that is already known to a person having ordinary skill in the art.

### SUMMARY

An object of the present disclosure is to provide a soft actuator capable of providing high vibration and pressure.

Another object of the present disclosure is to provide a massage device including a soft actuator capable of providing both an acupressure effect through pressure and a tapping effect through vibration. The massage device may be incorporated into a vehicle seat.

Still another object of the present disclosure is to provide a massage device capable of relieving pain and irritation experienced by a user, owing to the flexibility of a soft actuator included in the massage device.

The object of the present disclosure is not limited to the foregoing, and other objects not mentioned herein will be clearly understood by one having ordinary skill in the art to which the present disclosure pertains based on the description below.

The features of the present disclosure to achieve the objects of the present disclosure as described above and perform the characteristic functions of the present disclosure to be described later are as follows.

In one aspect, the present disclosure provides a soft actuator including a soft pressing portion configured to expand or contract by a pressure fluid filling in the soft pressing portion, and a soft vibrating portion including an electrode and configured to provide vibration through shape change due to voltage applied to the electrode.

In another aspect, the present disclosure provides a massage device including: a soft actuator including a soft pressing portion configured to expand or contract by a pressure fluid filling in the soft pressing portion, and a soft vibrating portion including an electrode and configured to provide vibration through shape change due to voltage applied to the electrode; and a cover having the soft actuator disposed in the cover. A vehicle seat may include the massage device.

In still another aspect, the present disclosure provides a vehicle seat including a backrest, a headrest connected to the backrest, and a massage device mounted between the backrest and the headrest. Here, the massage device may include: a soft actuator including a soft pressing portion configured to expand or contract by a pressure fluid filling in the soft pressing portion, and a soft vibrating portion including an electrode and configured to provide vibration through shape change due to voltage applied to the electrode; and a cover having one or more of the soft actuator disposed in the cover. A vehicle may include the vehicle seat, or one or more of the vehicle seat(s).

Other aspects and preferred embodiments of the present disclosure are discussed infra.

### BRIEF DESCRIPTION OF THE DRAWINGS

The above and other features of the present disclosure will now be described in detail with reference to certain exemplary embodiments thereof illustrated in the accompanying drawings which are given hereinbelow by way of illustration only, and thus are not limitative of the present disclosure, and wherein:

FIG. 1 illustrates a soft actuator according to an embodiment of the present disclosure;

FIGS. 2A and 2B illustrate a soft pressing portion of a soft actuator according to an embodiment of the present disclosure, where FIG. 2A illustrates a state in which the soft pressing portion is contracted and FIG. 2B illustrates a state in which the soft pressing portion is expanded;

FIGS. 3A and 3B illustrate a soft vibrating portion of a soft actuator according to an embodiment of the present disclosure, where FIG. 3A illustrates a state before a voltage is applied to the soft vibrating portion and FIG. 3B illustrates a state in which a voltage is applied to the soft vibrating portion;

FIG. 4 illustrates the dotted box portion in FIG. 3A;

FIG. 5 illustrates a massage device including a soft actuator according to some forms of the present disclosure; and

FIGS. 6 and 7 illustrate a vehicle seat to which the massage device of FIG. 5 is applied.

It should be understood that the appended drawings are not necessarily to scale, presenting a somewhat simplified representation of various preferred features illustrative of the basic principles of the present disclosure. The specific design features of the present disclosure, including, for example, specific dimensions, orientations, locations, and shapes, will be determined in part by the particular intended application and usage environment.

In the figures, the reference numbers refer to the same or equivalent parts of the present disclosure throughout the several figures of the drawing.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Descriptions of specific structures or functions presented in the embodiments of the present disclosure are merely exemplary for the purpose of explaining the embodiments according to the concept of the present disclosure, and the embodiments according to the concept of the present disclosure may be implemented in various forms. In addition, the descriptions should not be construed as being limited to the embodiments described herein, and should be understood to include all modifications, equivalents and substitutes falling within the idea and scope of the present disclosure.

In this specification, the terms “first,” “second,” etc. may be used to describe various components, but the components are not limited to the terms. These terms are only used to distinguish one component from another. For example, a first component could be termed a second component, and similarly, a second component could be termed a first component, without departing from the scope of exemplary embodiments of the present disclosure.

It should be understood that when a component is referred to as being “connected to” or “brought into contact with” another component, the component may be directly connected to or brought into contact with the other component or intervening components may also be present. In contrast, when a component is referred to as being “directly connected to” another component, there are no intervening components present. Other terms used to describe relationships between components should be interpreted in a like fashion (e.g., “between” versus “directly between,” “adjacent” versus “directly adjacent,” etc.).

Throughout the specification, like reference numerals indicate like components. The terminology used herein is for the purpose of illustrating embodiments and is not intended to limit the present disclosure. In this specification, the singular form includes plural forms unless specified otherwise.

Hereinafter, the present disclosure will be described with reference to the accompanying drawings.

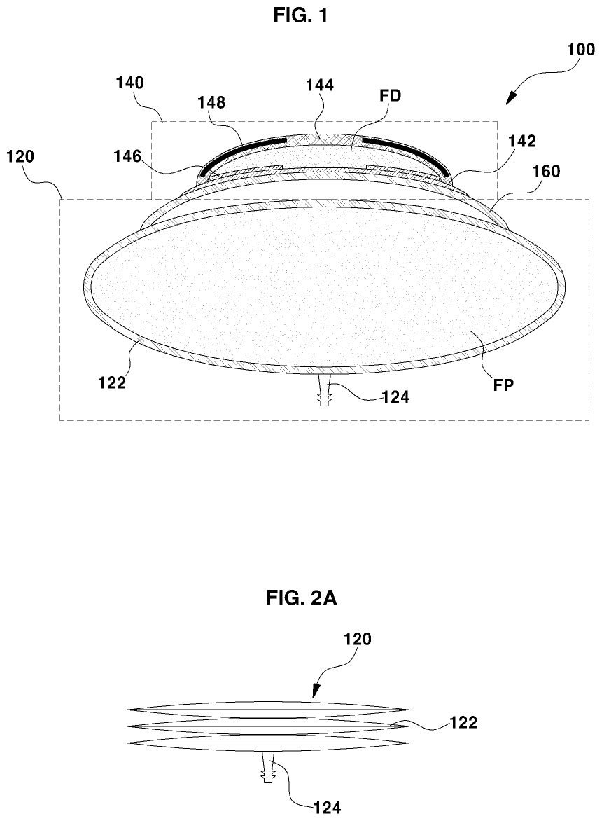

A soft actuator 100 according to the present disclosure may provide both an acupressure effect through pressure and a tapping effect through vibration. To this end, as illustrated in FIG. 1, the soft actuator 100 according to the present disclosure includes a soft pressing portion 120 and a soft vibrating portion 140.

The soft pressing portion 120 may cause changes in pressure and volume in the soft actuator 100. In one implementation, the soft pressing portion 120 includes an outer skin 122 made of an elastic material. As a non-limiting example, the outer skin 122 may be made of an elastic polymer material. The outer skin 122 may vary in shape depending on the intended use or purpose.

The outer skin 122 may have a chamber in the outer skin 122. The chamber may be filled with a pressure fluid FP. As a non-limiting example, either a gas, such as air, or a liquid, such as water, may be used as the pressure fluid FP. In one implementation, the outer skin 122 has a fluid passageway 124. The pressure fluid FP may be introduced into and discharged from a space in the outer skin 122 through the fluid passageway 124.

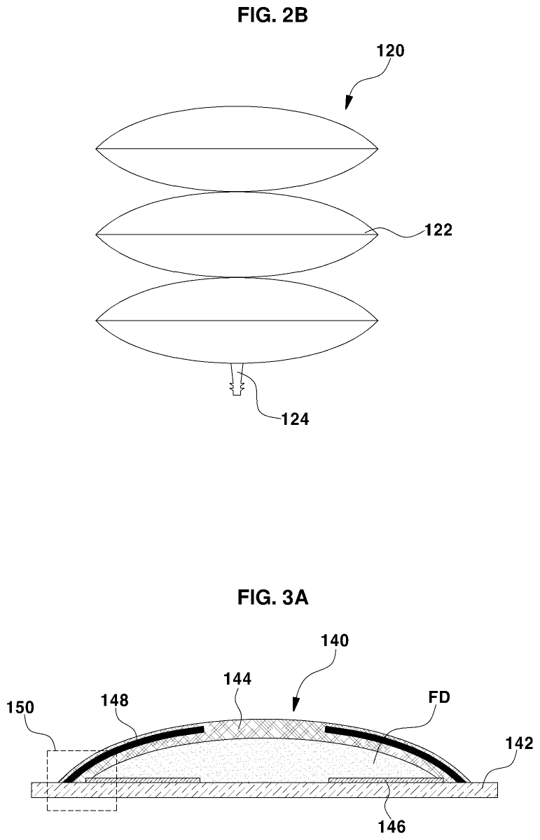

As illustrated in FIGS. 2A and 2B, the pressure and volume of the soft pressing portion 120 may change. Through the fluid passageway 124, the pressure fluid FP may be introduced into the chamber in the outer skin 122. The outer skin 122 may expand or contract as the pressure fluid FP is introduced into or discharged from the chamber. When the pressure fluid FP is discharged from the chamber, the soft pressing portion 120 may contract as in FIG. 2A. When the pressure fluid FP is introduced into the chamber, the soft pressing portion 120 may expand as in FIG. 2B.

Referring back to FIG. 1, the soft vibrating portion 140 may generate vibrations of various frequencies in the soft actuator 100. In one implementation, the soft vibrating portion 140 includes a substrate layer 142. The substrate layer 142 may be made of an elastic material. A film 144 may be connected to the substrate layer 142, and a dielectric fluid FD may fill a space defined by the substrate layer 142 and the film 144. In one implementation, in order to improve the intensity of vibration force, the film 144 may be made of an electroactive polymer that induces charges on the surface thereof when a voltage is applied. For example, the film 144 may be made of polyvinyl chloride (PVC) gel. In some implementations, the dielectric fluid FD may be an incompressible fluid.

Moreover, the soft vibrating portion 140 includes electrodes 146 and 148. A first electrode 146 may be laminated on the substrate layer 142. A second electrode 148 may be laminated on the surface of the film 144 or inside the film 144. The first electrode 146 may be disposed on the substrate layer 142 appropriately, depending on the operating shape of the soft vibrating portion 140. The second electrode 148 may be freely disposed so long as the second electrode 148 at least partially overlaps the first electrode 146 but does not contact the first electrode 146.

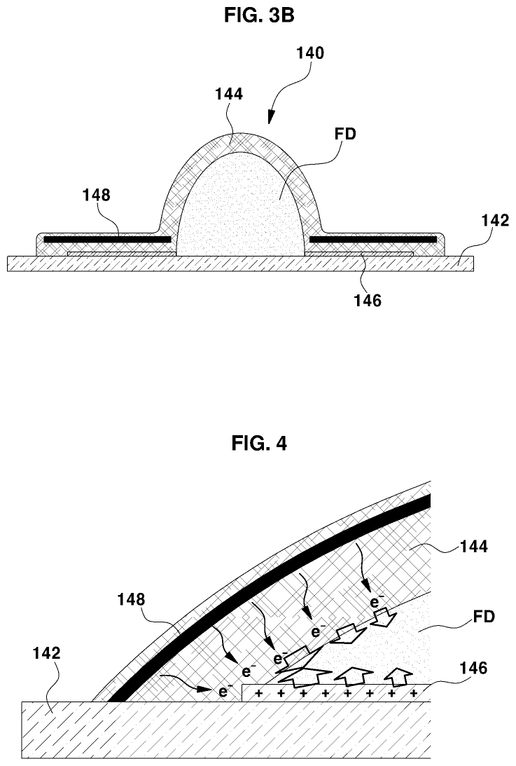

FIG. 3A illustrate the state of the soft vibrating portion 140 in which a voltage is not applied to the electrodes 146 and 148. In this state, the substrate layer 142 and the film 144 are connected to each other at a contact portion 150 to confine the dielectric fluid FD in the space defined by the substrate layer 142 and the film 144. Except for the contact portion 150, the substrate layer 142 and the film 144 are separated from each other.

FIG. 3B illustrates the soft vibrating portion 140 in which a voltage is applied to the electrodes 146 and 148 in the state of FIG. 3A. When the voltage is applied to the first electrode 146 and to the second electrode 148, electrostatic attraction occurs between the two electrodes 146 and 148. The electrostatic attraction causes the film 144 and the first electrode 146 to push the dielectric fluid FD present therebetween and to be brought into contact with each other at an area where the electrodes 146 and 148 overlap each other. Due to the incompressibility of the dielectric fluid FD, the shape of the soft vibrating portion 140 may change. The waveform and/or frequency of the voltage applied to the soft vibrating portion 140 may be adjusted, thereby generating various vibrations.

Referring to FIG. 4, the film 144 is made of an electroactive polymer, and when a voltage is applied to the electrodes 146 and 148, electric charges may be induced on the surface of the film 144 in contact with the electrodes 146 and 148. Negative charges e− may be induced on the inner surface of the film 144 in contact with the positively (+) charged first electrode 146. Here, because electrical attraction occurs between negative charges e−, induced on the surface of the film 144, and positive charges+, induced in the first electrode 146, a gap between the negative charges and the positive charges may be very small, compared to the electrostatic attraction that occurs between the two electrodes 146 and 148. Therefore, high electrostatic attraction may occur.

The soft pressing portion 120 and the soft vibrating portion 140 may be coupled to each other via a coupling portion 160. The coupling portion 160 is configured to physically couple the soft pressing portion 120 and the soft vibrating portion 140 to each other. As an example, the soft pressing portion 120 and the soft vibrating portion 140 may be physically coupled to each other using a coupling member. As another example, the soft pressing portion 120 and the soft vibrating portion 140 may be chemically bonded to each other. When the soft pressing portion 120 and the soft vibrating portion 140 are coupled to each other in the latter manner, the coupling portion 160 may not have a physical shape. The method of coupling the soft pressing portion 120 to the soft vibrating portion 140 is not limited to the exemplified ones but may be other known methods.

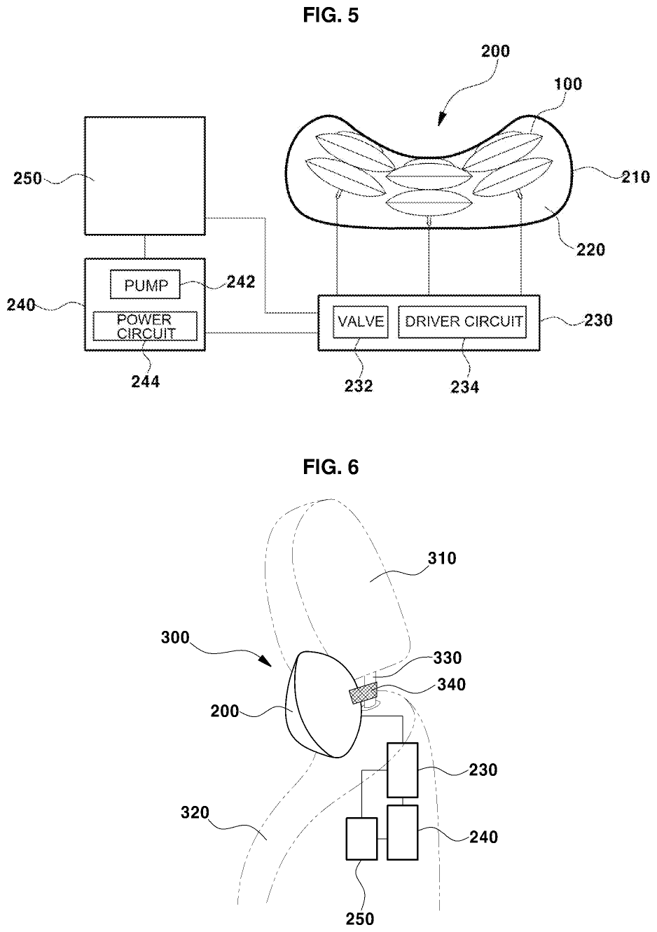

According to some embodiments of the present disclosure, with reference to FIG. 5, a massage device 200 may include the soft actuator 100. In the illustrated implementation, the soft actuator 100 is applied to a neck massager.

The massage device 200 includes a cover 210 and a buffer material 220. The cover 210 is a portion that directly contacts a body part for massage. In case of a neck massager, the cover 210 may have a curved shape to cover the neck. The soft actuator 100 may be disposed within the cover 210, and additionally the buffer material 220 may fill the cover 210.

The soft actuator 100 has a switcher 230 connected thereto. The switcher 230 may switch the flow of the pressure fluid FP and current supplied to the soft actuator 100. Specifically, the switcher 230 may include a valve 232 configured to control the flow of fluid supplied to the soft pressing portion 120. Moreover, the switcher 230 may include a driver circuit 234 configured to control the flow of a high voltage current supplied to the soft vibrating portion 140.

The soft actuator 100 may be connected to a supplier 240. For example, the soft actuator 100 may be connected to the supplier 240 via the switcher 230. The supplier 240 may supply fluid and power to the soft actuator 100. The supplier 240 includes a pump 242 configured to supply a high-pressure fluid to the soft pressing portion 120. Moreover, the supplier 240 includes a power circuit 244 configured to supply a needed voltage and power to the switcher 230, the supplier 240, and a controller 250.

The soft actuator 100 further includes the controller 250. The controller 250 may control the operation of the soft actuator 100. For example, the controller 250 may control the operation of the switcher 230 and the supplier 240. Furthermore, the controller 250 may control the overall operation sequence of the massage device 200.

The massage device 200 including the soft actuator 100 according to the present disclosure may provide both acupressure and tapping effects and allow a user to wear and use the massage device without discomfort, owing to the high flexibility of the soft actuator 100.

FIG. 6 illustrates a seat 300 including the massage device 200. The seat 300 includes a headrest 310 and a backrest 320. The headrest 310 may be mounted to the backrest 320 by being movable with respect to the backrest 320. The headrest 310 coupled to the backrest 320 via a support 330 movable with respect to the backrest 320 is adjustable in height depending on the sitting height of the person seated on the seat 300.

The massage device 200 may be mounted between the headrest 310 and the backrest 320. For example, the massage device 200 may be mounted to the support 330. In one example, the massage device 200 may be coupled to the support 330 via a mounting portion 340. The mounting portion 340 may be various types of fastening members, such as a strap and a fastener.

In one implementation, the switcher 230, the supplier 240, and the controller 250 of the massage device 200 may be imbedded in the seat 300 or may be disposed externally.

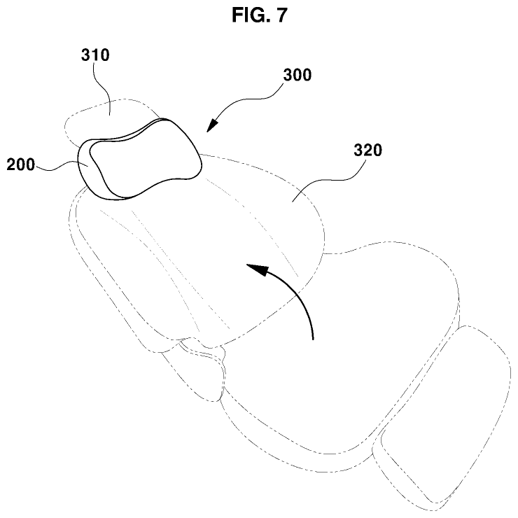

As illustrated in FIG. 7, when the massage device 200 is applied to the reclining seat 300, the comfort and massage sensation provided to the seated person may be maximized.

For instance, the seat 300 may be a seat for vehicles. However, the seat 300 is not limited thereto but may be an armchair, a massage chair, and the like.

As is apparent from the above description, the present disclosure provides the following effects.

According to the present disclosure, provided is a soft actuator capable of providing high vibration and pressure.

According to the present disclosure, provided is a massage device including a soft actuator capable of providing both an acupressure effect through pressure and a tapping effect through vibration.

Moreover, the massage device according to the present disclosure may relieve pain and irritation experienced by a user, owing to the flexibility of a soft actuator included in the massage device.

Effects of the present disclosure are not limited to what has been described above, and other effects not mentioned herein will be clearly recognized by those skilled in the art based on the above description.

It will be apparent to those of ordinary skill in the art to which the present disclosure pertains that the present disclosure described above is not limited by the above-described embodiments and the accompanying drawings, and various substitutions, modifications and changes are possible within a range that does not depart from the technical idea of the present disclosure.

What is claimed is:

1. A soft actuator for a massage device, the soft actuator comprising:
a soft pressing portion configured to expand or contract by a pressure fluid being injected in the soft pressing portion; and
a soft vibrating portion comprising an electrode and configured to provide vibration through shape change due to a voltage applied to the electrode.

2. The soft actuator of claim 1, wherein the soft pressing portion comprises an outer skin made of an elastic material, and the pressure fluid is filled in the outer skin.

3. The soft actuator of claim 2, wherein the outer skin is made of an elastic polymer material.

4. The soft actuator of claim 1, wherein the soft pressing portion comprises a fluid passageway configured to introduce or discharge the pressure fluid.

5. The soft actuator of claim 1, wherein the soft vibrating portion comprises:
a substrate layer made of an elastic material;
a film made of an electroactive polymer material connected to the substrate layer and encapsulating a dielectric fluid in a space defined by the substrate layer and the film; and
a first electrode and a second electrode to which the voltage is applied and which are operably associated with each other.

6. The soft actuator of claim 5, wherein the first electrode is disposed on the substrate layer and the second electrode is disposed in the film, and wherein the second electrode at least partially overlaps the first electrode but does not contact the first electrode.

7. The soft actuator of claim 5, wherein the film and the substrate layer are connected to each other only at a contact portion therebetween.

8. The soft actuator of claim 1, wherein a waveform or frequency of the voltage applied to the electrode is configured to be adjustable.

9. The soft actuator of claim 1, further comprising a coupling portion configured physically or chemically bond the soft pressing portion and the soft vibrating portion to each other.

10. A massage device comprising:
a soft actuator comprising a soft pressing portion configured to expand or contract by a pressure fluid being injected in the soft pressing portion, and a soft vibrating portion comprising an electrode and configured to provide vibration through shape change due to a voltage applied to the electrode; and
a cover having the soft actuator disposed in the cover.

11. The massage device of claim 10, further comprising a switcher configured to switch flows of the pressure fluid and current supplied to the soft pressing portion.

12. The massage device of claim 10, further comprising a supplier configured to supply the pressure fluid and power to the soft actuator.

13. The massage device of claim 10, further comprising a controller configured to control an operation of the soft actuator, wherein the controller is configured to control flows of the pressure fluid and current supplied to the soft actuator.

14. A vehicle seat comprising the massage device of claim 10.

15. A vehicle seat comprising:
a backrest;
a headrest connected to the backrest; and
a massage device mounted between the backrest and the headrest,
wherein the massage device comprises:
a soft actuator comprising a soft pressing portion configured to expand or contract by a pressure fluid being injected in the soft pressing portion, and a soft vibrating portion comprising an electrode and configured to provide vibration through shape change due to a voltage applied to the electrode; and
a cover having one or more of the soft actuators disposed in the cover.

16. The vehicle seat of claim 15, wherein the headrest is movably connected to the backrest.

17. The vehicle seat of claim 15, wherein the massage device is mounted to a support configured to connect the headrest and the backrest to each other.

18. A vehicle comprising the vehicle seat of claim 15.
